(19) United States
(12) Patent Application Publication
(10) Pub. No.: US 2015/0053786 A1
(43) Pub. Date: Feb. 26, 2015

(54) INTELLIGENT PRECISION IRRIGATION SYSTEM

(71) Applicant: Trimble Navigation Limited, Sunnyvale, CA (US)

(72) Inventor: Uriel Rosa, Woodland, CA (US)

(21) Appl. No.: 13/972,537

(22) Filed: Aug. 21, 2013

(51) Int. Cl. A01G 25/16; A01G 25/09

(52) U.S. Cl. CPC A01G 25/165; A01G 25/09
USPC 239/69

(57) ABSTRACT

An intelligent precision irrigation system is disclosed. In one embodiment, the intelligent precision irrigation system comprises a power generator is coupled with a pipeline conveying a material. The power generator is configured to generate power when the material passes by the power generator. The intelligent precision irrigation system further comprises a valve coupled with the pipeline which is configured to control the flow of the material through the pipeline. The intelligent precision irrigation system further comprises an electronic controller configured to generate an instruction to the valve to control the flow of the material through the pipeline.

### BACKGROUND

Current agricultural practice is moving toward using technology to more precisely control what practices are to be implemented. This includes crop selection, planting schedules, fertilization and pest control, harvesting, transport, etc. An important consideration is the irrigation scheduling. More specifically, when to irrigate and how much water to apply based upon precipitation, the water holding capacity of the soil, and where in the growing cycle the crop currently is in. Because water allocation between farming and other commercial activities has to be balanced with metropolitan use and ecological considerations, it is increasingly important to precisely control irrigation of crops as well.

### BRIEF DESCRIPTION OF THE DRAWINGS

The accompanying drawings, which are incorporated in and form a part of this application, illustrate embodiments of the subject matter, and together with the description of embodiments, serve to explain the principles of the embodiments of the subject matter. Unless noted, the drawings referred to in this brief description of drawings should be understood as not being drawn to scale.

FIG. 1 is a block diagram of an irrigation network in accordance with various embodiments.

FIG. 2A shows an example sprinkler system in accordance with various embodiments.

FIG. 2B shows an example sprinkler system in accordance with various embodiments.

FIG. 2C shows an example sprinkler system in accordance with various embodiments.

FIG. 2D shows an example sprinkler system in accordance with various embodiments.

FIG. 2E shows an example sprinkler system in accordance with various embodiments.

FIG. 3A shows an example irrigation system in accordance with various embodiments.

FIG. 3B shows an example irrigation system in accordance with various embodiments.

FIG. 4A shows an example power generator in accordance with various embodiments.

FIG. 4B shows an example power generator in accordance with various embodiments.

FIG. 4C shows an example power generator in accordance with various embodiments.

FIG. 5 is a block diagram of an example controller for a sprinkler system used in accordance with various embodiments.

FIG. 6 is a block diagram of an example computer system used in accordance with various embodiments.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope as defined by the appended claims. In some embodiments, all or portions of the electronic computing devices, units, and components described herein are implemented in hardware, a combination of hardware and firmware, a combination of hardware and computer-executable instructions, or the like. Furthermore, in the following description, numerous specific details are set forth in order to provide a thorough understanding of the subject matter. However, some embodiments may be practiced without these specific details. In other instances, well-known methods, procedures, objects, and circuits have not been described in detail as not to unnecessarily obscure aspects of the subject matter.

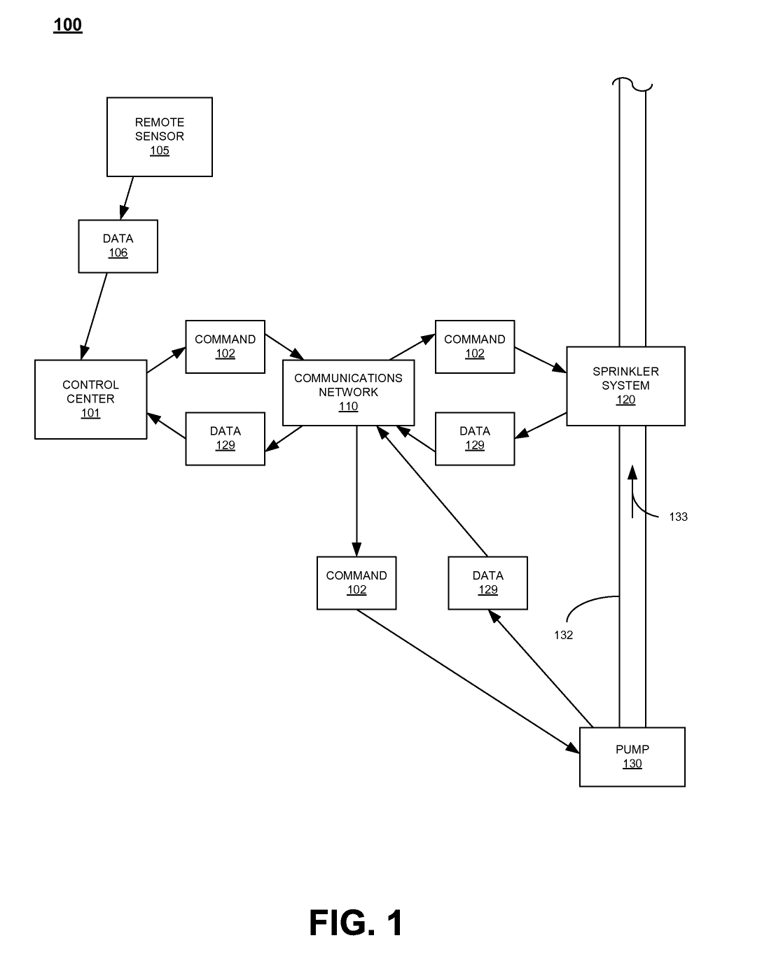

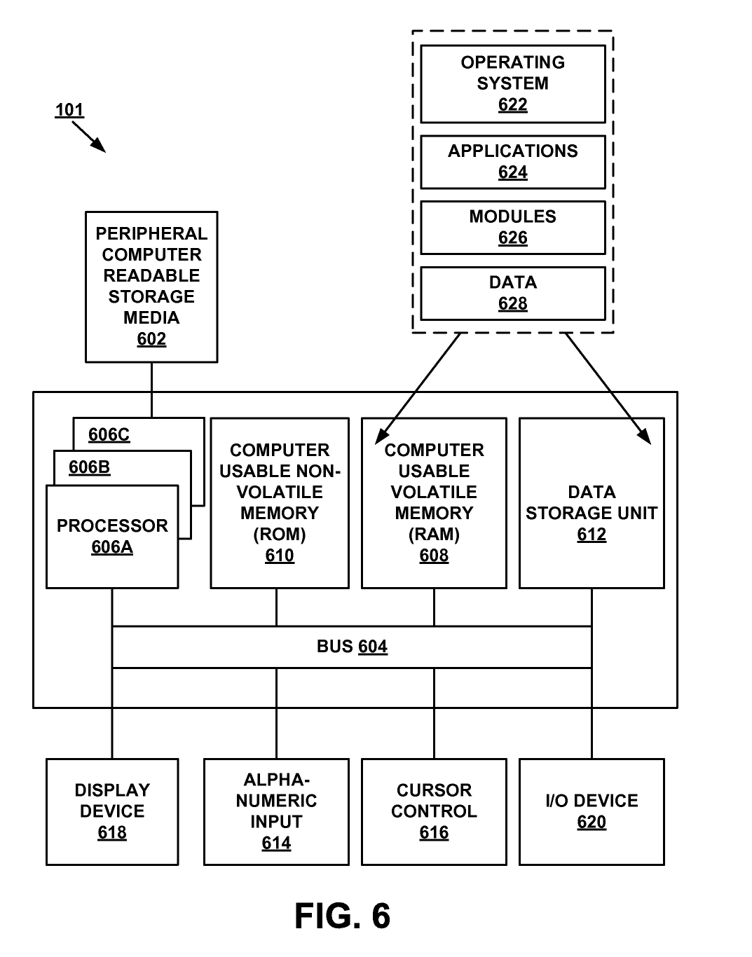

FIG. 1 is a block diagram of an irrigation network 100 in accordance with various embodiments. In FIG. 1, network 100 comprises a control center 101. In accordance with various embodiments, control center 101 is used to control the flow of fluids or gasses through pipeline 132. In the following examples, operation of irrigation network 100 will focus on the use of network 100 for the purpose of agricultural irrigation. However, various embodiments are well suited for controlling other types of pipelines such as those used to convey other liquids such as petroleum products, chemicals, or the like. Other embodiments are well suited for controlling pipelines which convey other materials including, but not limited to, gases such as natural gas for commercial/residential use. In accordance with various embodiments, control center 101 comprises computer systems (e.g., 600 of FIG. 6), databases, communication transceivers, and other devices used to facilitate decision making processes and control of pipeline 132. Additionally, control center 101 can be implemented as a stand-alone entity, or integrated into other networks. In FIG. 1, control center 101 receives data 106 from remote sensor(s) 105. In accordance with various embodiments, remote sensor(s) 105 can comprise satellite imagery or data, aerial imagery or data, or terrestrially collected data such as from vehicle mounted, or handheld, sensors. Examples of data 106 include, but are not limited to weather data, projected weather data, crop data (e.g., crop height, crop cycle data, nitrogen content, etc.), ground moisture content, or the like which are used in deciding whether additional irrigation is needed in a given area. In FIG. 1, control center 101 generates commands (e.g., 102) via communications network 110 to sprinkler system 120 and/or pump 130 to respectively direct operation of these devices. In accordance with various embodiments, communications network 110 comprises a landline network, a wireless network, or a combination of both. Additionally, sprinkler system 120 and/or pump 130 are configured to collect and report data (e.g., 129) to control center 101 to facilitate in the operation of network 100. In accordance with one embodiment, sprinkler system 120 and/or pump 130 can be configured with the capability to store and forward data. Thus, for example, pump 130 can received, store, and forward messages from control center 101 which are destined for sprinkler system 120 and to receive, store, and forward data from sprinkler system 120 which is destined for control center 101.

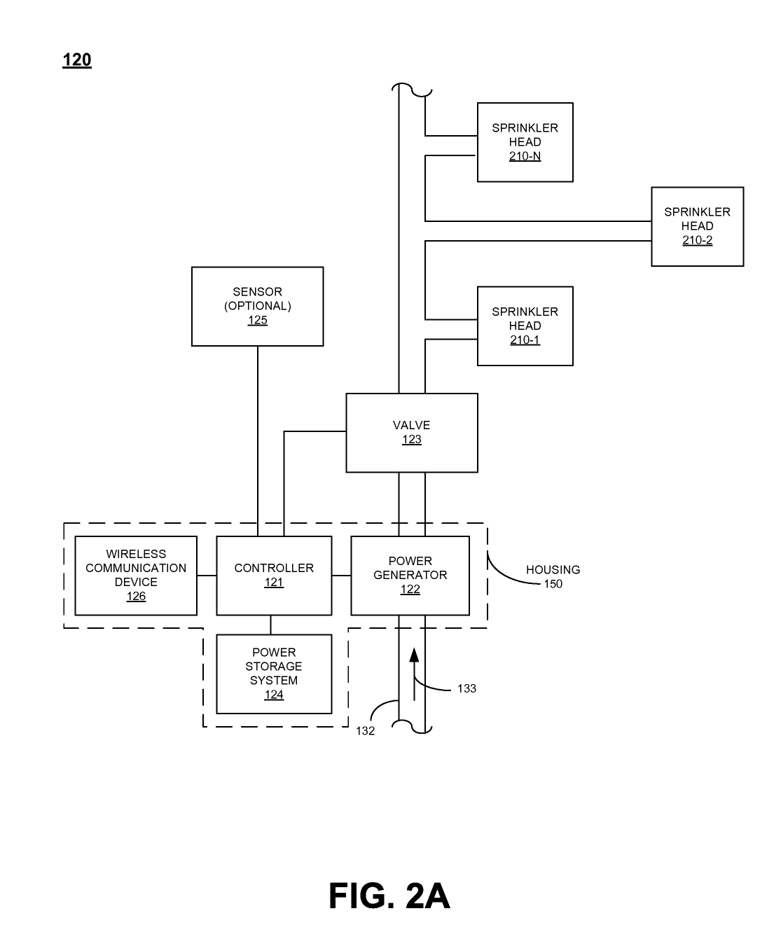

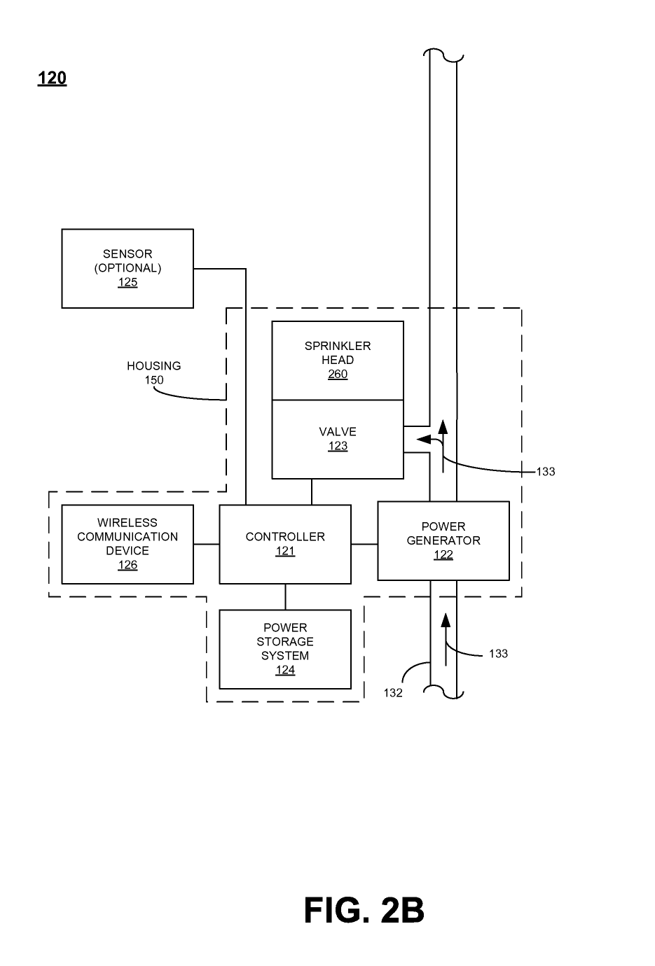

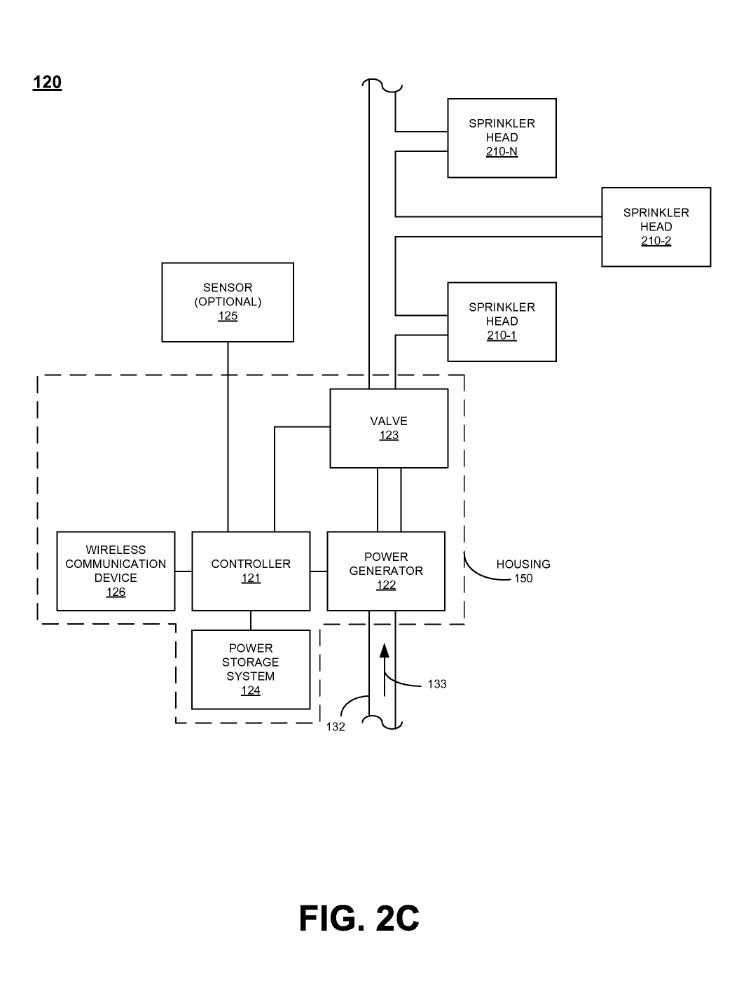

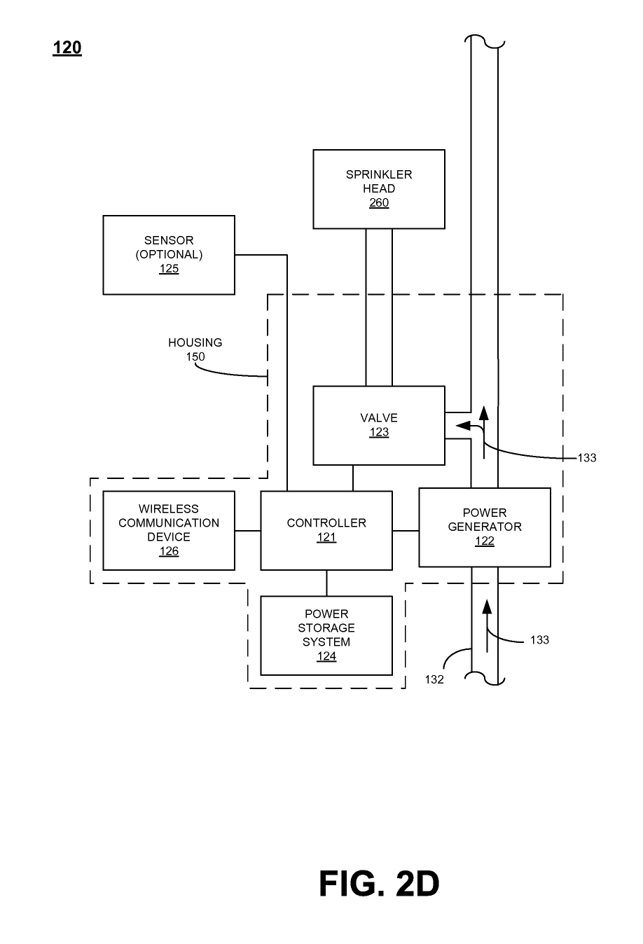

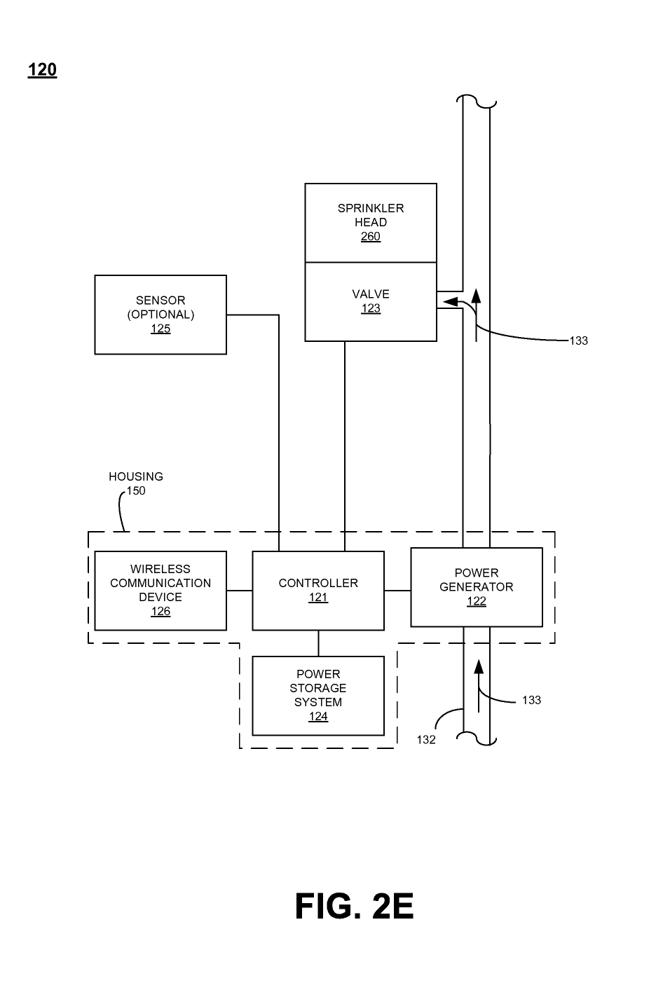

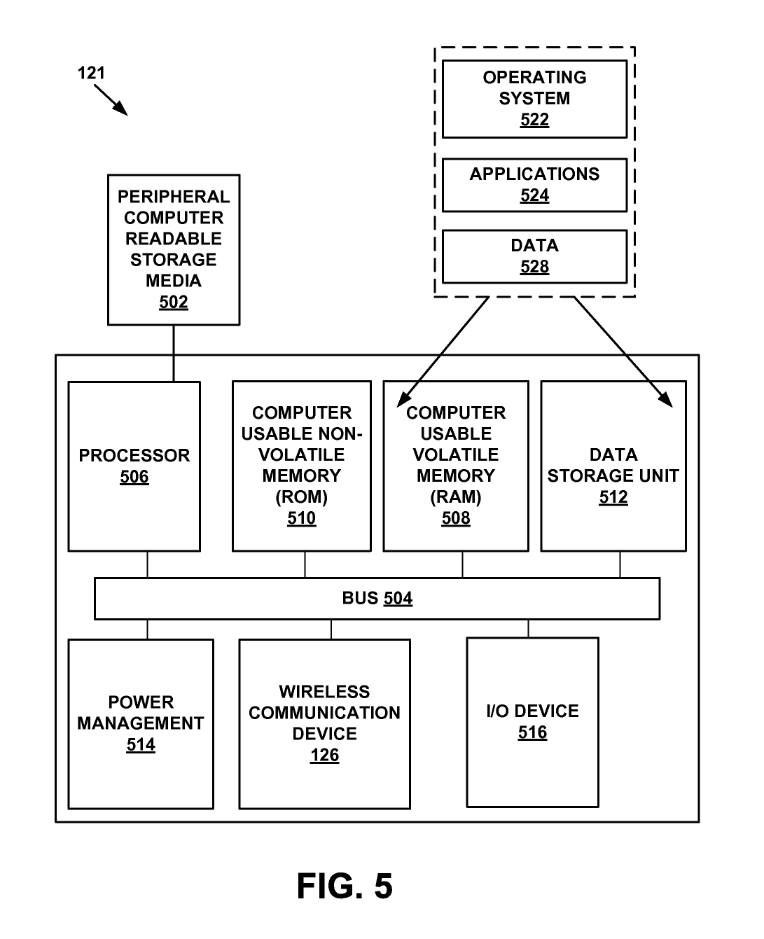

FIG. 2A shows an example sprinkler system 120 in accordance with various embodiments. In FIG. 2A, sprinkler system 120 comprises a controller 121 which is coupled with a power generator 122 and a valve 123. In accordance with various embodiments, controller 121 comprises a processor and other components used to implement commands 102 received from control center 101, to receive, store, and report data (e.g., from optional sensor 125, or power management component 514 of FIG. 5). Sprinkler system 120 further comprises a wireless communication device 126, a power storage system 124, and an optional sensor 125. In the embodiment of FIG. 2A, controller 121, power generator 122, power storage system 124, and wireless communication device 126 are disposed within a housing 150. In accordance with various embodiments, sprinkler system 120 is configured such that power generated by power generator 122 is used locally to power and recharge other proximate components. In other words, power generator 122 is not configured to power other devices than the components of sprinkler system 120. In the embodiment of FIG. 2A, valve 123 controls the flow 133 of water through pipeline 132. In other words, when valve 123 is closed, no water will flow past to, for example, sprinkler heads 210-1, 210-2, 210-N. It is noted that other valves 123, as well as the other components of sprinkler system 120 described above, may be disposed further downstream along pipeline 132 such as between sprinkler heads 210-1 and 210-2, or between sprinkler heads 210-2 and 210-N. In operation, the disposition of valve 123 is governed by controller 121. Thus, for example, in response to a command 102 from control center 101, controller 121 may open valve 123 to permit a water to flow through pipeline 132 to the sprinkler heads coupled therewith. Control center 101 can also generate a command 102 to controller 121 to shut valve 123 when irrigation is to be terminated. FIG. 2C shows an example sprinkler system 120 which is similar to the configuration described above with reference to FIG. 2A with the exception that valve 123 is disposed within housing 125.

In accordance with various embodiments, wireless communication device 126 may comprise either of a wireless communication receiver or transceiver operable to utilize any suitable wireless communication protocol including, but not limited to: WiFi, WiMAX, WWAN, implementations of the IEEE 802.11 specification, cellular, two-way radio, satellite-based cellular (e.g., via the Inmarsat or Iridium communication networks), mesh networking, implementations of the IEEE 802.15.4 specification for personal area networks, and implementations of the Bluetooth® standard. Personal area networks refer to short-range, and often low-data-rate, wireless communications networks. In operation, wireless communication device 126 is used to receive commands 102 from control center 101 and to convey data 129 to control center 101 via communications network 110 when sprinkler system 120 is configured to report data. For example, in FIG. 2A, an optional sensor 125 is coupled with controller 121. In accordance with various embodiments, sensor 125 can include, but is not limited to, sensors which report data regarding precipitation, ground water holding capacity, or the like which may be used by control center 101 in determining an irrigation plan for sprinkler system 120. Alternatively, sensor 125 can facilitate autonomous operation of sprinkler system 120. For example, if sensor 125 comprises a ground water sensor, controller 121 can determine whether the ground water content has fallen below a pre-determined threshold. In response, controller 121 will autonomously generate a command to open valve 123. In one embodiment, controller 121 will open valve 123 for a pre-determined time interval. After another time interval has elapsed, to permit the water to penetrate the soil, controller 121 can again compare the ground water content with the pre-determined threshold.

In accordance with various embodiments, power storage system 124 comprises a battery or capacitor which stores energy for the operation of controller 121, valve 123, sensor 125, and/or wireless communication device 126. In accordance with various embodiments, power storage system 124 interacts with power management component 514 such as for monitoring the state of charging of power storage system 124.

In accordance with various embodiments, power generator 122 is for generating electrical current when a flow 133 of material (e.g., a gas, water or other liquid, etc.) passes through pipeline 132. For example, in the embodiment shown in FIG. 2A, when valve 123 is opened and water flows through pipeline 132, electrical power is generated when the water flows past power generator 122. As will be explained in greater detail below, power generator 122 comprises an impeller coupled with a generator. In another embodiment, power generator 122 comprises a piezo-electric element coupled with a generator. Thus, in accordance with various embodiments, power generator 122 facilitates operation of sprinkler system 120 without the requirement of electrical wiring to power the system. This reduces the cost and complexity of installing an irrigation system, or other pipeline system. Additionally, some farmers are reporting thievery of electrical wiring from their irrigation systems. Due to the reduced need for electrical wiring, sprinkler system 120 lessens this risk for the farmer. It is noted that other sources of electricity, such as solar panels, can be used to supplement the power supplied by power generator 122.

FIG. 2B shows an example sprinkler system 120 in accordance with various embodiments. For the sake of brevity, the present discussion will not repeat a description of components described above with reference to FIG. 2A. In the embodiment shown in FIG. 2B, valve 123 controls the flow 133 of a material to sprinkler head 260 alone without affecting the flow 133 of that material through pipeline 132. In the embodiment of FIG. 2B, controller 121, power generator 122, valve 123, power storage system 124, wireless communication device 126, and sprinkler head 260 are disposed within a housing 150. Again, accordance with various embodiments, sprinkler system 120 is configured such that power generated by power generator 122 is used locally to power and recharge other proximate components. In other words, power generator 122 is not configured to power other devices than the components of sprinkler system 120. In the embodiment shown in FIG. 2B, valve 123 and sprinkler head 260 are integrated as a single component of sprinkler system 120 and sprinkler head 260 is also disposed within housing 150. In another embodiment, as shown in FIG. 2D, valve 123 and sprinkler head 260 are separate components which can be disposed at respective locations. In yet another embodiment as shown in FIG. 2E, valve 123 and sprinkler head are integrated in a single component which is separate from controller 121, power generator 122, power storage system 124, and wireless communication device 126 which are disposed within housing 150. In operation, flow 133 of water through pipeline 132 can continue while valve 123 is closed in the embodiment shown in FIG. 2B. As a result, individual sprinkler heads 260 can be opened/closed without affecting the flow of water to other sprinkler systems 120 coupled with pipeline 132. Additionally, power generator 122 can generate power for sprinkler system 120 even when valve 123 is closed in the embodiment shown in FIG. 2B. This permits much finer granularity in controlling the irrigation of a field. Also, as described above sprinkler system 120 can operate autonomously when coupled with sensors such as sensor 125. As will be discussed in greater detail below, this permits allowing for differences within a given field such as soil type, or ground conformation, which create micro-zones within the field that can be accommodated using embodiments of sprinkler system 120.

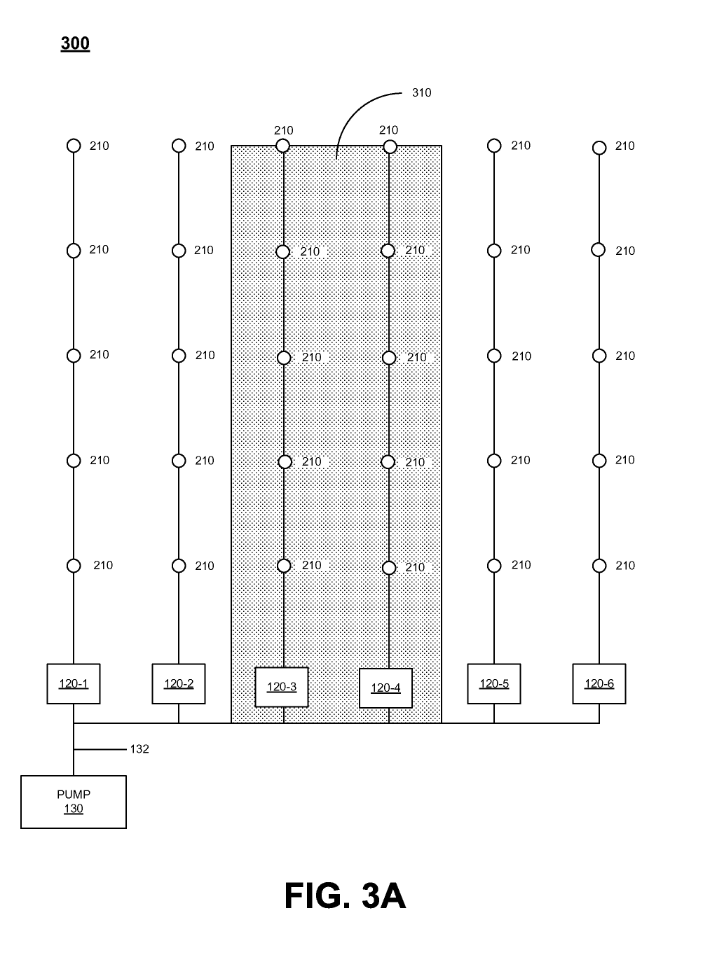

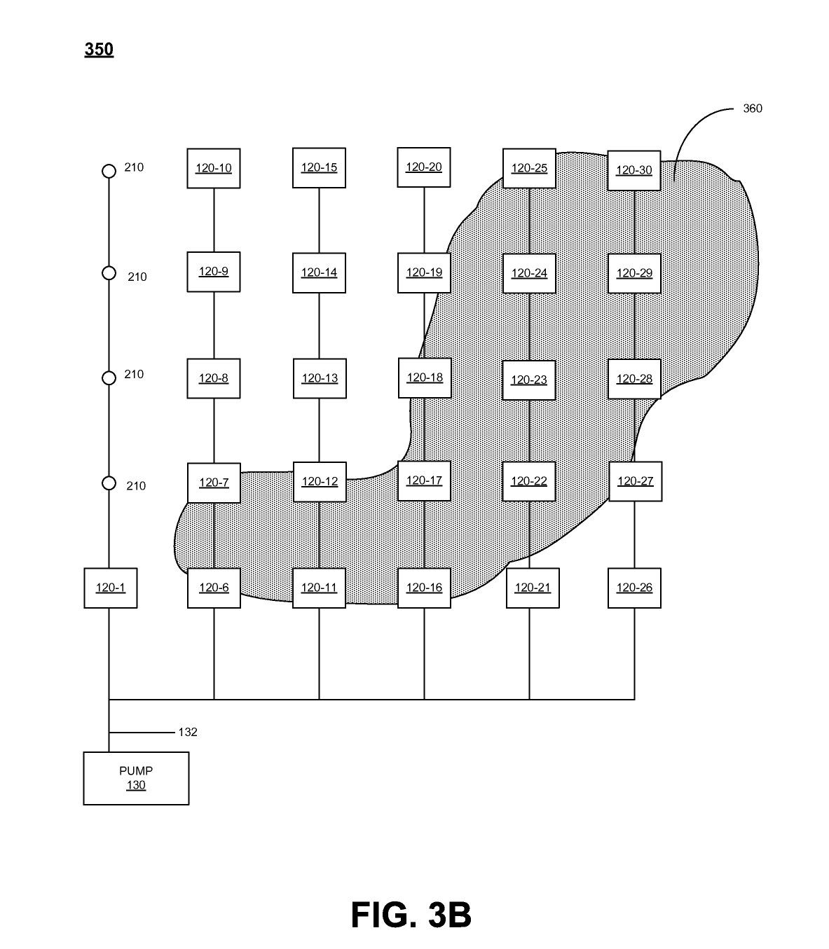

FIG. 3A shows an example irrigation system 300 in accordance with various embodiments. For purposes of discussion, the irrigation system 300 shown in FIG. 3A implements a sprinkler system 120 shown in FIG. 2A exclusively. It is noted that other implementations are possible as discussed below. In FIG. 3A, a plurality of sprinkler systems 120 (e.g., 120-1, 120-2, 120-3, 120-4, 120-5, and 120-6) are coupled with pump 130 via pipeline 132. In accordance with one embodiment, pump 130 is coupled with control center 101 via a wireless communications network 110 such as a wireless communications network. In FIG. 3A, each of sprinkler systems 120-1, 120-2, 120-3, 120-4, 120-5, and 120-6 are respectively coupled with a plurality of sprinkler heads 210. Also shown in FIG. 3A is a shaded region 310 representing a ridgeline through a field. Because water runoff from ridgeline 310 will cause some of the water from sprinkler systems 120-3 and 120-4 to tend to run down into adjacent downhill areas, more water will be needed in the areas of sprinkler systems 120-3 and 120-4 and less water will be needed in the areas of sprinkler systems 120-2 and 120-5. In accordance with various embodiments, this can be implemented by giving more water to sprinkler systems 120-3 and 120-4 (e.g., by irrigating longer or by irrigating more often). Similarly, the areas served by sprinkler systems 120-2 and 120-5 can receive less water (e.g., by irrigating for a shorter period or by irrigating less often).

FIG. 3B shows an example irrigation system 350 in accordance with various embodiments. In the embodiment shown in FIG. 3B, irrigation system 350 uses the sprinkler system 120 shown in FIG. 2B. As with FIG. 3A, a plurality of sprinkler systems 120 (e.g., 120-1-120-30) are coupled with pump 130 via pipeline 132. Unlike the implementation shown in FIG. 3A, each sprinkler system 120 is individually controlled by a respective controller 121. As a result, much greater control can be realized in the pattern, amount, and timing of irrigation. For example, the shaded region 360 represents a low lying area in a field which will tend to collect water and hold it as ground water than surrounding portions of the field. As a result, less water will need to be applied via the sprinkler systems 120-6, 120-7, 120-11, 120-12, 120-16, 120-17, 120-18, 120-22, 120-23, 120-24, 120-25, 120-28, 120-29, and 120-30. Again, this can be implemented by watering less often, or for shorter periods when compared to other sprinkler systems 120 used in irrigation system 350. Additionally, sprinkler systems 120 adjacent to region 360 (e.g., 120-19 and 120-27) may also receive less water to reduce the amount of runoff into region 360. It is noted that in various embodiments, a combination of the irrigation systems 300 and 350 shown respectively in FIGS. 3A and 3B can be implemented. For example, in FIG. 3B, an area which does not lie within region 360 can be replaced by a single-line sprinkler system 120 (e.g., sprinkler system 120-1) in which a single controller 121 controls the flow of water to a plurality of sprinkler heads 210. This can reduce the cost and complexity of installing and controlling irrigation system 350. As discussed above, using sensor 125, irrigation system 350 can autonomously determine whether irrigation is needed at a given time. For example, sensors coupled with sprinkler systems 120-1-120-30 can determine the ground water content proximate to their respective sprinkler systems. As an example, sprinkler systems 120-6, 120-7, 120-11, 120-12, 120-16, 120-17, 120-18, 120-22, 120-23, 120-24, 120-25, 120-28, 120-29, and 120-30 will likely detect a greater ground water content than other sprinkler systems of irrigation system 350 as they are disposed in low-lying ground. As a result, the respective controllers 121 of sprinkler systems 120-6, 120-7, 120-11, 120-12, 120-16, 120-17, 120-18, 120-22, 120-23, 120-24, 120-25, 120-28, 120-29, and 120-30 will initiate irrigation less often than the sprinkler systems 120 lying outside of shaded region 360. This results in lower water usage and reduces the possibility of over-watering crops growing within shaded region 360, or under-watering crops growing outside of shaded region 360.

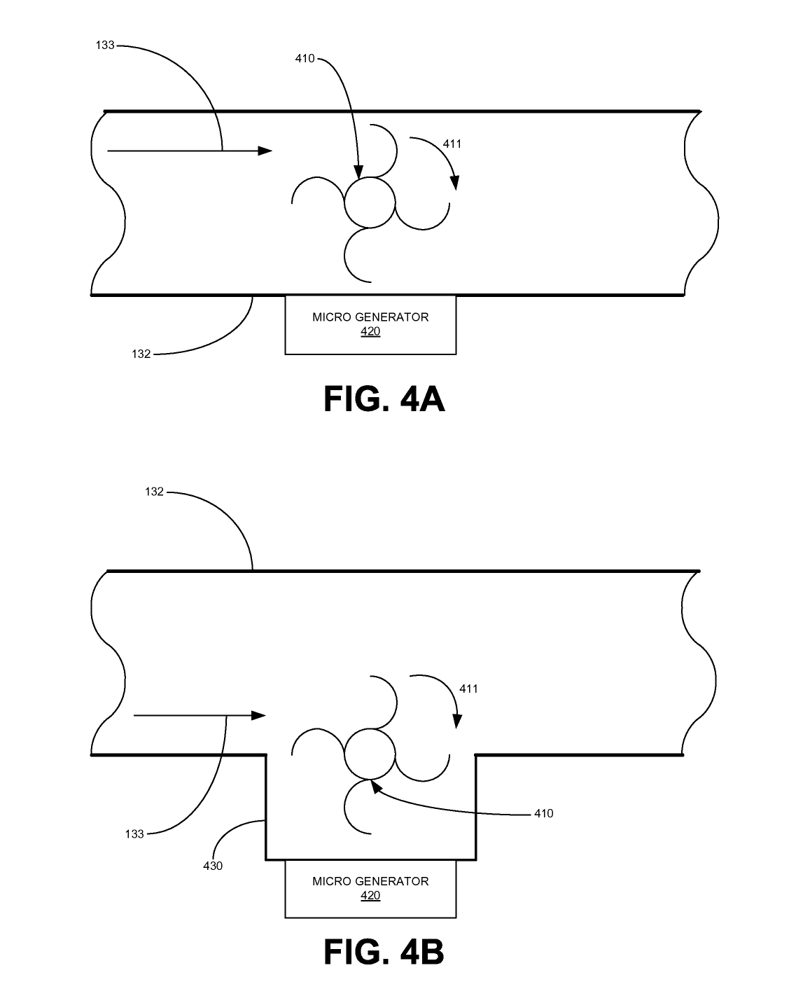

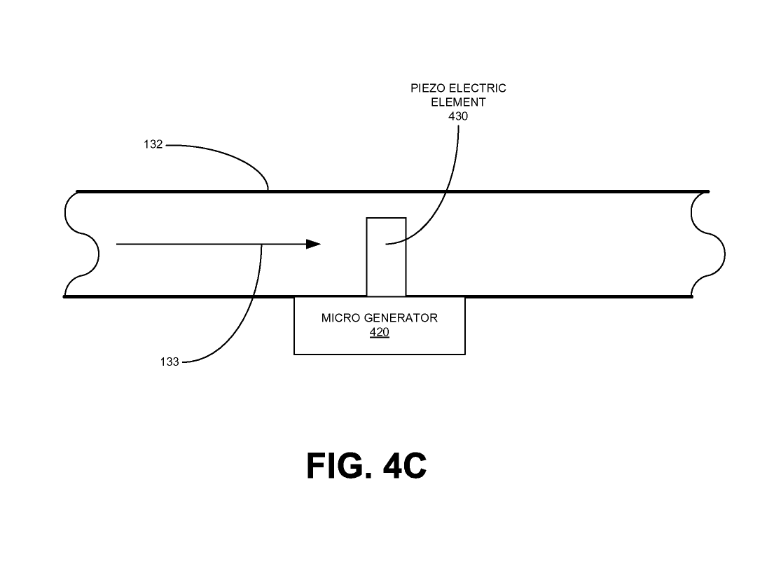

FIG. 4A shows an example power generator 12 in accordance with various embodiments. In the embodiment shown in FIG. 4A, an impeller 410 is placed into the flow 133 of water through pipeline 132. As water passes by impeller 410 it rotates in the direction shown by arrow 411. The shaft of impeller 410 is coupled with a micro generator 420 which generates electricity for charging power storage system 124. It is noted that impeller 410 can be implemented in a variety of ways including, but not limited to, a propeller, a paddle, a turbine, etc.

FIG. 4B shows an example power generator 122 in accordance with various embodiments. In FIG. 4B, impeller 410 is partially disposed within a housing 430 which moves impeller 410 outside of flow 133 to some extent. While FIG. 4B shows impeller 410 moved outside of flow 133, it is noted that impeller 410 can be moved in to, or out of, flow 133 to a greater or lesser degree than shown in FIG. 4B. As with FIG. 4A above, impeller 410 is coupled with micro generator 420 which generates electricity as flow 133 causes impeller 410 to rotate to rotate in the direction of arrow 411.

FIG. 4C shows an example power generator 122 in accordance with various embodiments. In FIG. 4C, micro generator 420 is coupled with a piezo-electric element 430 disposed within flow 133 of pipeline 132. Piezo-electric generators convert mechanical strain into electrical current. In accordance with various embodiments, piezo-electric element 430 comprises a single-layer or multi-layer piezo-electric element which flexes or vibrates as flow 133 moves past it. This flexing or movement causes an electrical current which can be captured by electrodes disposed adjacent to the layer(s) of piezo-electric material comprising piezo-electric element 430. In so doing, micro generator 420 can generate electrical current which can be used to charge power storage system 124.

### Example Controller

With reference now to FIG. 5, all or portions of some embodiments described herein are composed of computer-readable and computer-executable instructions that reside, for example, in computer-usable/computer-readable storage media of a computer system. That is, FIG. 5 illustrates one example of a type of controller (e.g., 121 of FIGS. 2A and 2B) that can be used in accordance with or to implement various embodiments which are discussed herein. Controller 121 of FIG. 5 is well adapted to having peripheral computer-readable storage media 502 such as, for example, a floppy disk, a compact disc, digital versatile disc, universal serial bus “thumb” drive, removable memory card, and the like coupled thereto.

Controller 121 of FIG. 5 includes an address/data bus 504 for communicating information, and a processor 506 coupled to bus 504 for processing information and instructions. Processor 506 may be any of various types of microprocessors. Controller 121 also includes data storage features such as a computer usable volatile memory 508, e.g., random access memory (RAM), coupled to bus 504 for storing information and instructions for processor 506. Controller 121 also includes computer usable non-volatile memory 510, e.g., read only memory (ROM), coupled to bus 504 for storing static information and instructions for processor 506. Also present in controller 121 is a data storage unit 512 (e.g., a magnetic or optical disk and disk drive) coupled to bus 504 for storing information and instructions. Controller 121 also includes power management component 514 for monitoring and controlling the state of power storage system 124 of FIGS. 2A and 2B. Controller 121 also includes an input/output (I/O) device 516 coupled to bus 504 for communicating with an external wireless communication device 126 such as shown in FIGS. 2A and 2B.

Referring still to FIG. 5, various other components are depicted for controller 121. Specifically, when present, an operating system 522, applications 524, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer readable storage media. As described above, in accordance with at least one embodiment, controller 121 is configured to act autonomously in controlling the operation of sprinkler system 120. For example, based upon data from sensor 125, controller 121 can be configured to autonomously determine whether irrigation is necessary for the region covered by its respective sprinkler head(s) (e.g., 210-1-210-N of FIG. 2A, or 260 of FIG. 2B). However, this does not preclude operating in conjunction with commands 102 from control center 101 as well.

### Example Computer System

With reference now to FIG. 6, all or portions of some embodiments described herein are composed of computer-readable and computer-executable instructions that reside, for example, in computer-usable/computer-readable storage media of a computer system. That is, FIG. 6 illustrates one example of a type of computer (computer system 600) that can be used in accordance with or to implement various embodiments which are discussed herein, such as control system 101, among others. It is appreciated that computer system 600 of FIG. 6 is only an example and that embodiments as described herein can operate on or within a number of different computer systems including, but not limited to, general purpose networked computer systems, embedded computer systems, server devices, various intermediate devices/nodes, stand-alone computer systems, handheld computer systems, multi-media devices, and the like. Computer system 600 of FIG. 6 is well adapted to having peripheral computer-readable storage media 602 such as, for example, a floppy disk, a compact disc, digital versatile disc, universal serial bus “thumb” drive, removable memory card, and the like coupled thereto.

System 600 of FIG. 6 includes an address/data bus 604 for communicating information, and a processor 606A coupled to bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors. System 600 also includes data storage features such as a computer usable volatile memory 608, e.g., random access memory (RAM), coupled to bus 604 for storing information and instructions for processors 606A, 606B, and 606C. System 600 also includes computer usable non-volatile memory 610, e.g., read only memory (ROM), coupled to bus 604 for storing static information and instructions for processors 606A, 606B, and 606C. Also present in system 600 is a data storage unit 612 (e.g., a magnetic or optical disk and disk drive) coupled to bus 604 for storing information and instructions. System 600 also includes an optional alphanumeric input device 614 including alphanumeric and function keys coupled to bus 604 for communicating information and command selections to processor 606A or processors 606A, 606B, and 606C. System 600 also includes an optional cursor control device 616 coupled to bus 604 for communicating user input information and command selections to processor 606A or processors 606A, 606B, and 606C. In one embodiment, system 600 also includes an optional display device 618 coupled to bus 604 for displaying information.

Referring still to FIG. 6, optional display device 618 of FIG. 6 may be a liquid crystal device, cathode ray tube, plasma display device or other display device suitable for creating graphic images and alphanumeric characters recognizable to a user. Optional cursor control device 616 allows the computer user to dynamically signal the movement of a visible symbol (cursor) on a display screen of display device 618 and indicate user selections of selectable items displayed on display device 618. Many implementations of cursor control device 616 are known in the art including a trackball, mouse, touch pad, joystick or special keys on alphanumeric input device 614 capable of signaling movement of a given direction or manner of displacement. Alternatively, it will be appreciated that a cursor can be directed and/or activated via input from alphanumeric input device 614 using special keys and key sequence commands. System 600 is also well suited to having a cursor directed by other means such as, for example, voice commands System 600 also includes an I/O device 620 for coupling system 600 with external entities. For example, in one embodiment, I/O device 620 is a modem for enabling wired or wireless communications between system 600 and an external network such as, but not limited to, the Internet.

Referring still to FIG. 6, various other components are depicted for system 600. Specifically, when present, an operating system 622, applications 624, modules 626, and data 628 are shown as typically residing in one or some combination of computer usable volatile memory 608 (e.g., RAM), computer usable non-volatile memory 610 (e.g., ROM), and data storage unit 612. In some embodiments, all or portions of various embodiments described herein are stored, for example, as an application 624 and/or module 626 in memory locations within RAM 608, computer-readable storage media within data storage unit 612, peripheral computer-readable storage media 602, and/or other tangible computer readable storage media.

Embodiments of the present technology are thus described. While the present technology has been described in particular embodiments, it should be appreciated that the present technology should not be construed as limited to these embodiments alone, but rather construed according to the following claims.

What is claimed is:

1. A system for controlling a pipeline, said system comprising:
a power generator coupled with a pipeline conveying a material and configured to generate power when said material passes by said power generator;
a valve coupled with the pipeline and configured to control the flow of said material through the pipeline; and
a controller configured to generate an instruction to said valve to control said flow of said material through the pipeline and wherein said power generator, and said electronic controller are disposed within a housing.

2. The system of claim 1 further comprising:
a power storage system coupled with said controller and wherein said valve and said power storage system are disposed within said housing.

3. The system of claim 2 wherein said power storage system comprises a capacitor.

4. The system of claim 2 wherein said power storage system comprises a battery.

5. The system of claim 1 further comprising:
a wireless communication device coupled with said controller and configured to communicatively couple said controller with a communication network and wherein said wireless communication device is disposed within said housing.

6. The system of claim 1 further comprising:
a sensor coupled with said controller and configured to provide data used to determine the control of the flow of said material through the pipeline.

7. The system of claim 1 wherein said power generator further comprises an impeller disposed within the pipeline and configured to convey mechanical energy to said generator.

8. The system of claim 1 wherein said power generator further comprises a piezo-electric generator.

9. The system of claim 1 wherein said valve is coupled with a sprinkler head.

10. A sprinkler system comprising:
at least one sprinkler head coupled with a pipeline;
a valve coupled with a pipeline and configured to control the flow of water through a pipeline;
a controller coupled with said valve and configured to generate an instruction to said valve to control the flow of water through a pipeline; and
a power generator coupled with the pipeline and configured to generate power when water flows through the pipeline and wherein said valve, said controller, and said power generator are disposed within a housing.

11. The sprinkler system of claim 10 further comprising:
a power storage system coupled with said controller and disposed within said housing.

12. The sprinkler system of claim 11 wherein said power storage system comprises a capacitor.

13. The sprinkler system of claim 11 wherein said power storage system comprises a battery.

14. The sprinkler system of claim 10 further comprising:
a wireless communication device coupled with said controller and configured to communicatively couple said controller with a communication network and wherein said wireless communication device is disposed within said housing.

15. The sprinkler system of claim 10 further comprising:
a sensor coupled with said controller and configured to provide data used to determine the control of the flow of water through the pipeline.

16. The sprinkler system of claim 15 further comprising:
a wireless communication device coupled with said controller and disposed within said housing and wherein said controller is configured to report data from said sensor to a control center and to control the flow of water through the pipeline based upon a message from said control center.

17. The sprinkler system of claim 10 further comprising:
a sensor coupled with said controller and configured to provide data used to determine the control of the flow of said water through the pipeline.

18. The sprinkler system of claim 10 wherein said valve comprises a component of said at least one sprinkler head and is configured to control the flow of water from the pipeline through said sprinkler head.

19. The sprinkler system of claim 10 wherein said valve controls the flow of water to a plurality of sprinkler heads coupled with the pipeline.

20. The sprinkler system of claim 10 wherein said power generator comprises an impeller disposed within the pipeline and configured to convey mechanical energy to said generator.

21. The sprinkler system of claim 10 wherein said power generator further comprises a piezo-electric generator.

22. An irrigation network comprising:
a control center;
a controller communicatively coupled with said control center via a wireless communication network;
a valve coupled with a pipeline and configured to control the flow of water through the pipeline based upon a command originating from said control center; and
a power generator coupled with the pipeline and configured to generate power when water flows through the pipeline and wherein said controller, said valve, and said power generator are disposed within a housing.

23. The irrigation network of claim 22 wherein said power generator comprises an impeller disposed within the pipeline and configured to convey mechanical energy to said generator.

24. The irrigation network of claim 22 wherein said power generator further comprises a piezo-electric generator.

25. The irrigation network of claim 22 further comprising:
a power storage system coupled with said controller and disposed within said housing.

26. The irrigation network of claim 25 wherein said power storage system comprises a capacitor.

27. The irrigation network of claim 25 wherein said power storage system comprises a battery.

28. The irrigation network of claim 22 further comprising:
a sensor coupled with said controller and configured to provide data used to determine the control of the flow of water through the pipeline; and
a wireless communication device coupled with said controller and wherein said controller is configured to report data from said sensor to said control center and wherein said wireless communication device is disposed within said housing.

29. The irrigation network of claim 22 wherein said valve comprises a component of said at least one sprinkler head and is configured to control the flow of water from the pipeline through said sprinkler head and wherein said sprinkler head is disposed within said housing.

30. The irrigation network of claim 22 wherein said valve controls the flow of water to a plurality of sprinkler heads coupled with the pipeline.
